(19) United States
(12) Patent Application Publication
(10) Pub. No.: US 2020/0008547 A1
(43) Pub. Date: Jan. 9, 2020

(54) LIQUID MEDICATION STORAGE ASSEMBLY

(71) Applicant: Deanna Hotop, Perryville, MO (US)

(72) Inventor: Deanna Hotop, Perryville, MO (US)

(21) Appl. No.: 16/026,862

(22) Filed: Jul. 3, 2018

(51) Int. Cl. A45C 11/00; B65D 25/10; B65D 43/16; B65D 25/56; A61J 7/00

(52) U.S. Cl. CPC A45C 11/00; B65D 25/10; A45C 2011/007; B65D 25/56; A61J 7/0076; B65D 43/16

(57) ABSTRACT

A liquid medication storage assembly for carrying a premeasured liquid medication on an airplane includes a box and a lid that is hingedly coupled to the box for closing the box. A card is provided that has a writing surface and indicia can be selectively written thereon. A large container is provided for containing a liquid medication and the large container is positionable in the box for storage. The large container has a fluid volume of less than 5.0 fluid ounces to conform to TSA regulations for taking liquid onto an airplane. A small container is provided for containing a single dosage of the liquid medication thereby facilitating the single dosage to be taken by a user. The small container has a fluid volume that is less than the fluid volume of the large container.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to storage devices and more particularly pertains to a new storage device for carrying a premeasured amount of liquid medication on an airplane.

### BRIEF SUMMARY OF THE INVENTION

An embodiment of the disclosure meets the needs presented above by generally comprising a box and a lid that is hingedly coupled to the box for closing the box. A card is provided that has a writing surface and indicia can be selectively written thereon. A large container is provided for containing a liquid medication and the large container is positionable in the box for storage. The large container has a fluid volume of less than 5.0 fluid ounces to conform to TSA regulations for taking liquid onto an airplane. A small container is provided for containing a single dosage of the liquid medication thereby facilitating the single dosage to be taken by a user. The small container has a fluid volume that is less than the fluid volume of the large container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a liquid medication storage assembly according to an embodiment of the disclosure.

FIG. 2 is a top view of an embodiment of the disclosure.

FIG. 3 is a bottom view of a box an embodiment of the disclosure.

FIG. 4 is a left side view of a box an embodiment of the disclosure.

FIG. 5 is a perspective view of small container of an embodiment of the disclosure.

FIG. 6 is a top view of an alternative embodiment of the disclosure. FIG. 7 is a perspective view of an alternative embodiment of the disclosure.

### DETAILED DESCRIPTION OF THE INVENTION

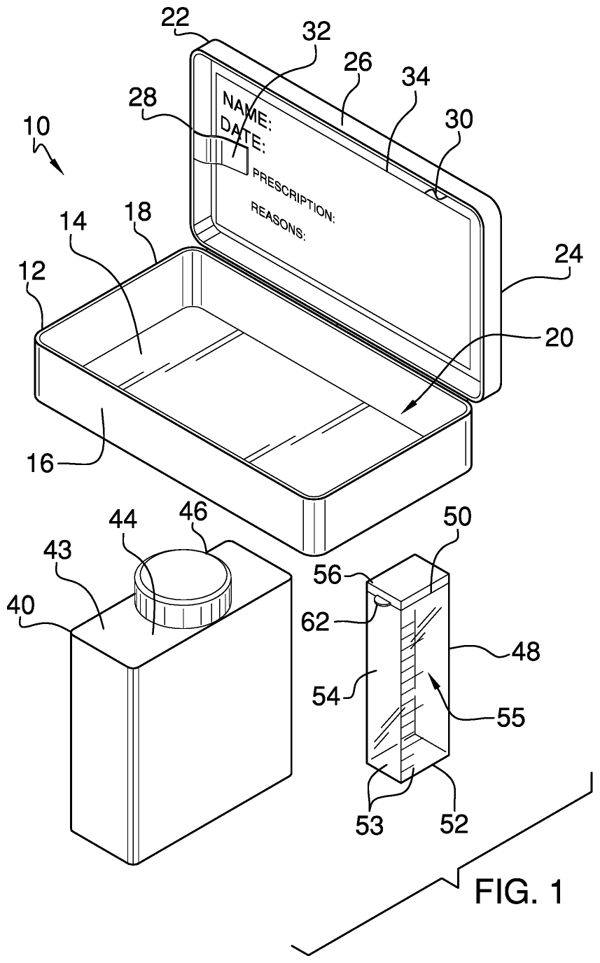

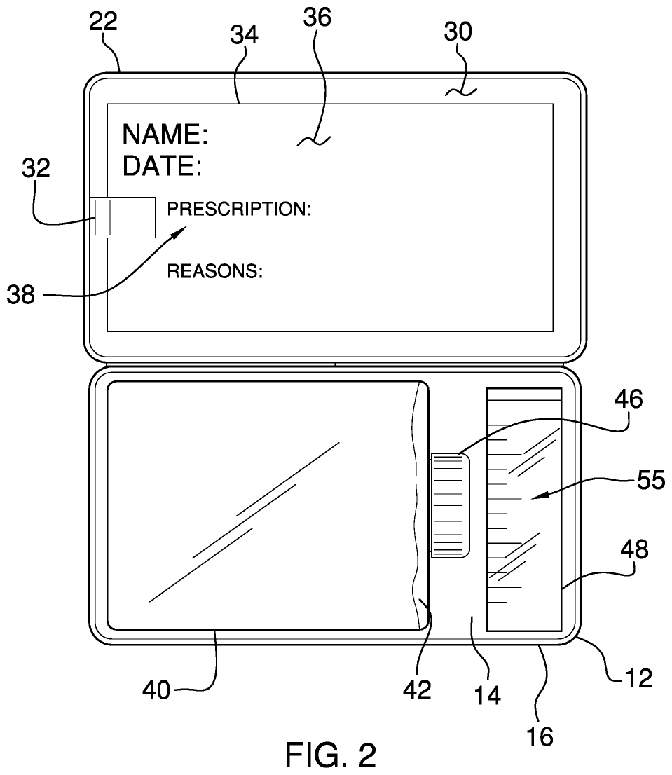

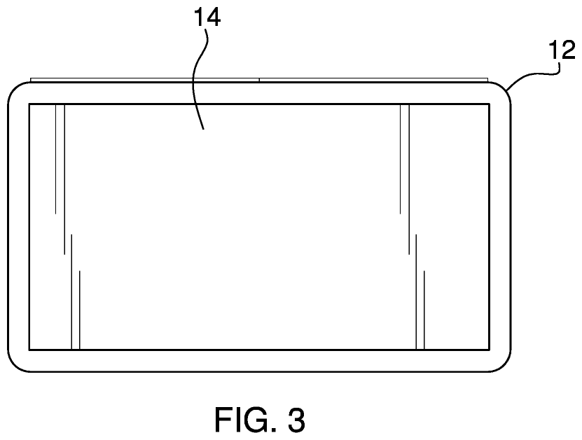

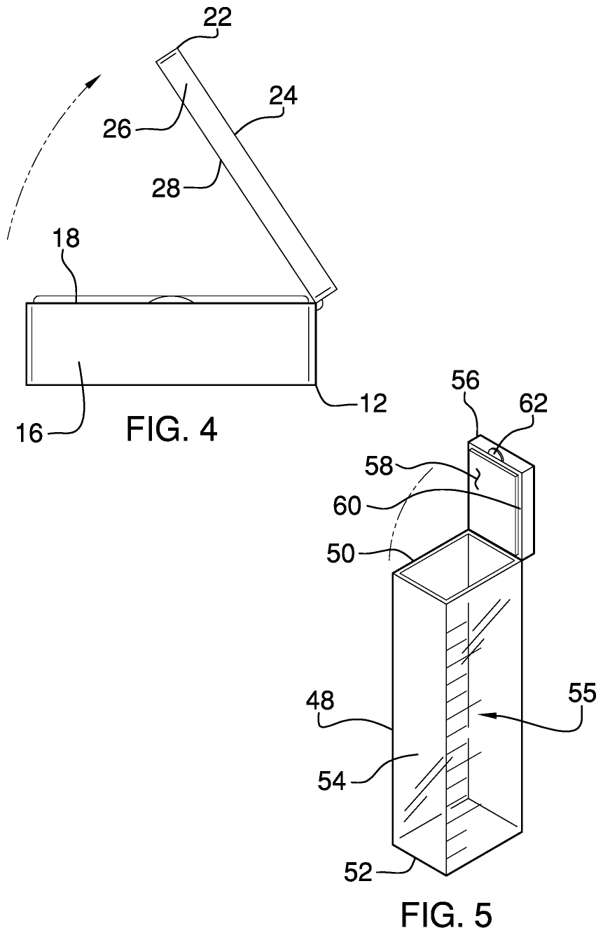

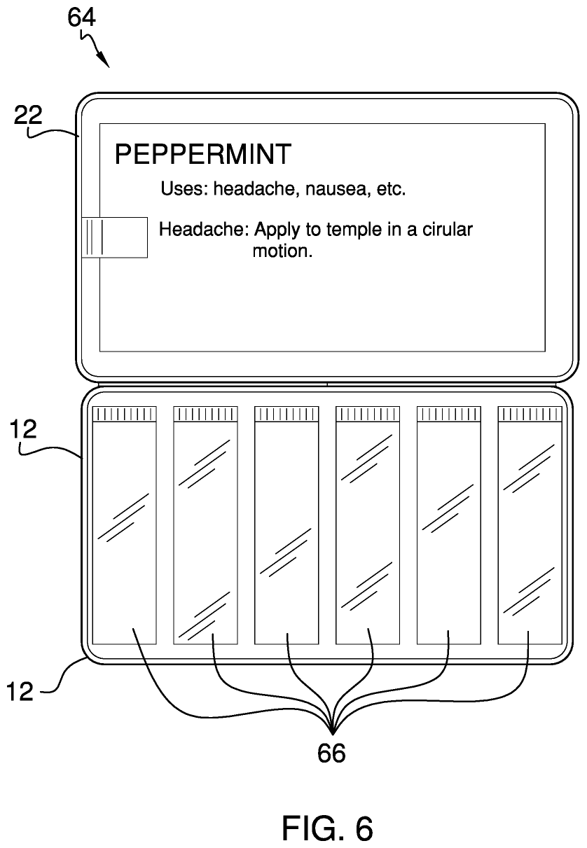

With reference now to the drawings, and in particular to FIGS. 1 through 7 thereof, a new storage device embodying the principles and concepts of an embodiment of the disclosure and generally designated by the reference numeral 10 will be described.

As best illustrated in FIGS. 1 through 7, the liquid medication storage assembly 10 generally comprises a box 12 that has a bottom wall 14 and an outer wall 16 extending upwardly therefrom. The outer wall 16 has a distal edge 18 with respect to the bottom wall 14 defining an opening 20 into the box 12. A lid 22 is hingedly coupled to the box 12 for closing the box 12. The lid 22 has a top wall 24 and an outside wall 26 extending downwardly therefrom, the outside wall 26 has a distal edge 28 with respect to the top wall 24 and the top wall 24 has an inside surface 30. A back side of the distal edge 28 of the lid 22 is hingedly coupled to a back side of the distal edge 18 of the box 12. Additionally, the distal edge 28 of the lid 22 rests on the distal edge 18 of the box 12 when the lid 22 is closed.

A clip 32 is coupled to the lid 22 and the clip 32 is positioned on the outside wall 26 of the lid 22. Moreover, the clip 32 is biased to frictionally engage the inside surface 30 of the top wall 24 of the lid 22. A card 34 is provided that has a writing surface 36 and indicia 38 is selectively written the writing surface 36. The indicia 38 comprise information about a prescription medication, a reason for taking the prescription medication, a name of the person taking the medication and a selected calendar date. The card 34 is positionable on the inside surface 30 of the lid 22 having the writing surface 36 being exposed for reading and the clip 32 engages the card 34 to retain the card 34 on the inside surface 30 of the lid 22.

A large container 40 is provided for containing a liquid medication 42, such as a liquid antihistamine, a liquid pain reliever or other liquid medication 42. The large container 40 is positionable in the box 12 for storage and the large container 40 has a fluid volume of less than 5.0 fluid ounces. Thus, the large container 40 conform to TSA regulations for taking liquid onto an airplane. The large container 40 has a top wall 43 and the top wall 43 has an opening 44 extending into an interior of the large container 40 for pouring the liquid medication 42. A cap 46 releasably engages the top wall 43 of the large container 40 for closing the opening 44 in the top wall 43.

A small container 48 is provided for containing a single dosage of the liquid medication 42 thereby facilitating the single dosage to be taken by a user. The small container 48 has a top end 50, a bottom end 52 and an outer wall 54 extending therebetween. The outer wall 54 may have a plurality of intersecting sides 53 such that the small container 48 has a cubic shape. The top end 50 is open and the outer wall 54 of the small container 48 is comprised of a translucent material such that the liquid medication 42 is visible therethrough. Moreover, the outer wall 16 has graduated indicia 55 printed thereon for measuring a liquid volume of the liquid medication 42 that is poured into the small container 48. The small container 48 has a fluid volume that is less than the fluid volume of the large container 40.

A cover 56 is hingedly coupled to the small container 48 for closing the small container 48. The cover 56 frictionally engages the small container 48 when the cover 56 is closed thereby inhibiting a child from opening the cover 56. Moreover, the cover 56 may frictionally engage the small container 48 through any conventional means with respect to child proof caps, lids and covers. The cover 56 has a first surface 58 and a back side of the first surface 58 is hingedly coupled to the top end 50 of the container. The first surface 58 has a groove 60 extending upwardly therein and extending around an entire perimeter of the first surface 58. The top end 50 of the container engages the groove 60 when the cover 56 is closed. A tab 62 is coupled to and extends away from the cover 56 from gripping the tab 62 when the cover 56 is closed thereby facilitating the cover 56 to be opened.

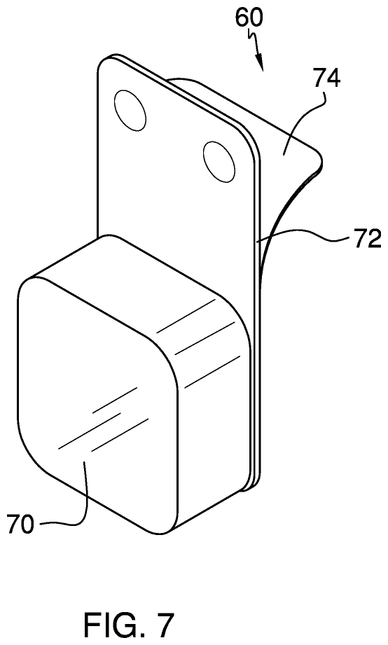

In an alternative embodiment 64 as shown in FIG. 6, a plurality of bottles 66 may be provided and each of the bottles 66 may contain a respective one of plurality of essential oils or other homeopathic remedy. Each of the bottles 66 may be positionable in the box 12 for storage and each of the bottles 66 may have a fluid volume is less than 5.0 fluid ounces. Thus, each of the bottles 66 conforms to TSA regulations for taking fluid onto an airplane.

In an alternative embodiment 68 as shown in FIG. 7, a prepackaged medication container 70 may be provided that contains the liquid medication 42 in a pre-determined volume. The prepackaged medication container 70 has a back side 72 and the back side 72 is open. The prepackaged medication container 70 has a fluid volume of less than 5.0 fluid ounces for conforming to TSA regulations for taking fluid onto an airplane. The prepackaged medication container 70 is positionable in the box 12 for storage. A barrier 74 is removably coupled to the back side 72 of prepackage medication container 70 to close the back side 72. The barrier 74 is removable from the prepackaged medication container 70 thereby facilitating the liquid medication 42 in the prepackaged medication container 70 to be consumed.

In use, a selected amount of the liquid medication 42 is poured into the large container 40. A measured amount, corresponding to a prescribed single dosage of the liquid medication 42, is poured from the large container 40 into the small container 48. Thus, the small container 48 facilitates the user to take the measured amount of the liquid medication 42 at a moment's notice. Each of the small 48 and large 40 containers are stored in the box 12, and all of the pertinent information regarding the liquid medication 42 is written on the writing surface 36 of the card 34. Moreover, the limited fluid volume of the large 40 and small 48 containers conforms to TSA regulations thereby facilitating the large 40 and small 48 containers to be taken onto a commercial airplane for air travel. In this way a parent can administer the liquid medication 42 to a child, in the prescribed dosage, on airplane without first needing to dispense a measured amount of the liquid medication 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. A liquid medication storage assembly being configured to contain a plurality of single doses of liquid medication, said assembly comprising:
a box;
a lid being hingedly coupled to said box for closing said box;
a card having a writing surface having indicia being selectively written thereon, said indicia comprising information about a prescription medication, a reason for taking the prescription medication, a name of the person taking the medication and a selected calendar date, said card being positionable on said inside surface of said lid having said writing surface being exposed for reading;
a large container for containing a liquid medication, said large container being positionable in said box for storage, said large container having a fluid volume of less than 5.0 fluid ounces wherein said large container is configured to conform to TSA regulations for taking liquid onto an airplane; and
a small container for containing a single dosage of the liquid medication wherein said small container is configured to facilitate the single dosage to be taken by a user, said small container having a fluid volume being less than said fluid volume of said large container.

2. The assembly according to claim 1, wherein:
said box has a bottom wall and an outer wall extending upwardly therefrom, said outer wall having a distal edge with respect to said bottom wall defining an opening into said box;
said lid has a top wall and an outside wall extending downwardly therefrom, said outside wall having a distal edge with respect to said top wall, said top wall having an inside surface, a back side of said distal edge of said lid being hingedly coupled to a back side of said distal edge of said box, said distal edge of said lid resting on said distal edge of said box when said lid is closed; and
a clip being coupled to said lid, said clip being positioned on said outside wall of said lid, said clip being biased to frictionally engage said inside surface of said top wall of said lid.

3. The assembly according to claim 2, wherein said clip engages said card to retain said card on said inside surface of said lid.

4. The assembly according to claim 1, wherein said large container has having a top wall, said top wall having an opening extending into an interior of said large container for pouring the liquid medication.

5. The assembly according to claim 1, wherein said small container has a top end, a bottom end and an outer wall extending therebetween, said top end being open, said outer wall being comprised of a translucent material such that the liquid medication is visible therethrough, said outer wall having graduated indicia being printed thereon for measuring a liquid volume of the liquid medication being poured into said small container.

6. The assembly according to claim 5, further comprising a cover being hingedly coupled to said small container for closing said small container, said cover frictionally engaging said small container when said cover is closed wherein said cover is configured to inhibit a child from opening said cover, said cover having a first surface, a back side of said first surface being hingedly coupled to said top end of said small container, said first surface having a groove extending upwardly therein and extending around an entire perimeter of said first surface, said top end of said small container engaging said groove when said cover is closed.

7. The assembly according to claim 6, further comprising a tab being coupled to and extending away from said cover from gripping said tab when said cover is closed thereby facilitating said cover to be opened.

8. The assembly according to claim 1, further comprising a plurality of bottles, each of said bottles containing a respective one of an essential oil, each of said bottles being positionable in said box for storage, each of said bottles having a fluid volume being less than 5.0 fluid ounces wherein each of said bottles is configured to conform to TSA regulations for taking fluid onto an airplane.

9. The assembly according to claim 1, further comprising a prepackaged medication container containing a fluid medication of a pre-determined volume, said prepacked medication container having a back side, said back side being open, said prepacked medication container having a fluid volume of less than 5.0 fluid ounces wherein said prepacked medication container is configured to conform to TSA regulations for taking fluid onto an airplane, said prepacked medication container being positionable in said box for storage.

10. The assembly according to claim 9, further comprising a barrier being removably coupled to said back side of medication container to close said back side, said barrier being removable from said medication container thereby facilitating the fluid medication in said prepacked medication container to be consumed.

11. A liquid medication storage assembly being configured to contain a plurality of single doses of liquid medication, said assembly comprising:
a box having a bottom wall and an outer wall extending upwardly therefrom, said outer wall having a distal edge with respect to said bottom wall defining an opening into said box;
a lid being hingedly coupled to said box for closing said box, said lid having a top wall and an outside wall extending downwardly therefrom, said outside wall having a distal edge with respect to said top wall, said top wall having an inside surface, a back side of said distal edge of said lid being hingedly coupled to a back side of said distal edge of said box, said distal edge of said lid resting on said distal edge of said box when said lid is closed;
a clip being coupled to said lid, said clip being positioned on said outside wall of said lid, said clip being biased to frictionally engage said inside surface of said top wall of said lid;
a card having a writing surface having indicia being selectively written thereon, said indicia comprising information about a prescription medication, a reason for taking the prescription medication, a name of the person taking the medication and a selected calendar date, said card being positionable on said inside surface of said lid having said writing surface being exposed for reading, said clip engaging said card to retain said card on said inside surface of said lid;
a large container for containing a liquid medication, said large container being positionable in said box for storage, said large container having a fluid volume of less than 5.0 fluid ounces wherein said large container is configured to conform to TSA regulations for taking liquid onto an airplane, said large container having having a top wall, said top wall of said large container having an opening extending into an interior of said large container for pouring the liquid medication;
a cap releasably engaging said top wall of said large container for closing said opening in said top wall of said large container;
a small container for containing a single dosage of the liquid medication wherein said small container is configured to facilitate the single dosage to be taken by a user, said small container having a top end, a bottom end and an outer wall extending therebetween, said top end being open, said outer wall of said small container being comprised of a translucent material such that the liquid medication is visible therethrough, said outer wall of said small container having graduated indicia being printed thereon for measuring a liquid volume of the liquid medication being poured into said small container, said small container having a fluid volume being less than said fluid volume of said large container;
a cover being hingedly coupled to said small container for closing said small container, said cover frictionally engaging said small container when said cover is closed wherein said cover is configured to inhibit a child from opening said cover, said cover having a first surface, a back side of said first surface being hingedly coupled to said top end of said small container, said first surface having a groove extending upwardly therein and extending around an entire perimeter of said first surface, said top end of said small container engaging said groove when said cover is closed; and
a tab being coupled to and extending away from said cover from gripping said tab when said cover is closed thereby facilitating said cover to be opened.

12. The assembly according to claim 11, further comprising a plurality of bottles, each of said bottles containing a respective one of an essential oil, each of said bottles being positionable in said box for storage, each of said bottles having a fluid volume being less than 5.0 fluid ounces wherein each of said bottles is configured to conform to TSA regulations for taking fluid onto an airplane.

13. The assembly according to claim 11, further comprising a prepackaged medication container containing a fluid medication of a pre-determined volume, said prepacked medication container having a back side, said back side being open, said prepacked medication container having a fluid volume of less than 5.0 fluid ounces wherein said prepacked medication container is configured to conform to TSA regulations for taking fluid onto an airplane, said prepacked medication container being positionable in said box for storage.

14. The assembly according to claim 13, further comprising a barrier being removably coupled to said back side of medication container to close said back side, said barrier being removable from said medication container thereby facilitating the fluid medication in said prepacked medication container to be consumed.
